(19) United States
(12) Patent Application Publication
(10) Pub. No.: US 2013/0219351 A1
(43) Pub. Date: Aug. 22, 2013

(54) METHOD OF DESIGNING A PHOTO MASK LAYOUT

(71) Applicant: Seong-Bo SHIM, Suwon-si (KR)

(72) Inventor: Seong-Bo SHIM, Suwon-si (KR)

(21) Appl. No.: 13/626,120

(22) Filed: Sep. 25, 2012

(30) Foreign Application Priority Data
Feb. 22, 2012 (KR) 10-2012-0018148

(51) Int. Cl. G06F 17/50

(52) U.S. Cl. 716/55

(57) ABSTRACT

A method of designing a photo mask layout may include selecting a target pattern from polygonal patterns in a layout, setting a reference point on the target pattern, obtaining a target raster at the reference point, and comparing the target raster with a hot-spot raster to determine whether the target pattern corresponds to a failure pattern.

### CROSS-REFERENCE TO RELATED APPLICATIONS

This U.S. non-provisional patent application claims priority under 35 U.S.C. §119 to Korean Patent Application No. 10-2012-0018148, filed on Feb. 22, 2012, in the Korean Intellectual Property Office, the entire contents of which are hereby incorporated by reference.

### BACKGROUND

1. Field

Example embodiments of the inventive concepts relate to a method of designing a photo mask layout, and in particular, to a method of generating a photomask layout, which may be used for fabricating a semiconductor device.

2. Description of the Related Art

A layout of circuit patterns to be transcribed on a wafer should be prepared in order to fabricate semiconductor devices on the wafer. Thereafter, by using a process proximity correction (PPC) and an optical proximity correction (OPC), a photomask layout is generated from the layout. However, there may be various failure patterns in the photomask layout. The failure patterns may be detected by various pattern-matching methods, e.g., a geometry-based design rule check (DRC) method or an image matching method. The DRC method has a problem in that the accuracy of the detection is strongly dependent on predetermined or given values given by a designer. In the image matching method, a relatively long time is required to finish the matching process, because the image matching method requires a one-to-one matching of image.

### SUMMARY

Example embodiments of the inventive concepts provide a method of designing a photomask layout, which can more easily classify a failure pattern. Example embodiments of the inventive concepts also provide a method of designing a photomask layout, which can improve or maximize productivity.

According to example embodiments of the inventive concepts, a method of designing a photomask layout may include selecting a target pattern from polygonal patterns in a layout, setting a reference point on the target pattern, obtaining a target raster at the reference point, and comparing the target raster with a hot-spot raster to determine whether the target pattern corresponds to a failure pattern.

In example embodiments, the target raster and the hot-spot raster include first and second arrays having first and second kernels, respectively. In example embodiments, each of the first and second kernels may be converted into a distribution density corresponding to an area overlapping the polygonal patterns adjacent to the reference point.

In example embodiments, each of the first and second kernels may include a circle whose diameter may be smaller than half of a minimum pitch between the polygonal patterns.

In example embodiments, the comparing the target raster with a hot-spot raster may include averaging absolute values of differences between the first and second kernels, and comparing the average with a given value. In example embodiments, the averaging calculates a weighting depending on a distance from the reference point to one of the first kernel and the second kernel.

In example embodiments, if the first and second arrays are square-shaped arrays, each of the first and second kernels includes a central kernel, horizontal central kernels, vertical central kernels, and remaining kernels.

In example embodiments, the comparing the target raster with a hot-spot raster may include comparing the central kernels of the first and second arrays with each other, comparing the horizontal central kernels and the vertical central kernels of the first and second arrays with each other if the central kernel of the first array is coincident to the central kernel of the second array, and comparing the remaining kernels of the first and second arrays with each other if the horizontal central kernels and the vertical central kernels of the first array are coincident to a corresponding one of the horizontal central kernels and the vertical central kernels of the second array.

In example embodiments, the comparing the horizontal central kernels and the vertical central kernels of the first and second arrays with each other may include averaging absolute values of differences between the horizontal central kernels and the vertical central kernels of the first and second arrays to obtain a first average, and comparing the first average with a first given value. The comparing the remaining kernels of the first and second arrays with each other may include averaging absolute values of differences between the remaining kernels of the first and second arrays to obtain a second average, and comparing the second average with a second given value.

In example embodiments, the distribution density may be calculated using one of circle function, Gaussian function, Lorentzian function, Bessel function, and Zernike function.

In example embodiments, each of the first and second arrays may be one of a square, radial, and diagonal array. In example embodiments, the reference point may be set as a central point on an edge of the target pattern.

According to example embodiments of the inventive concepts, a method of designing a photomask layout may include selecting a target pattern from one of a plurality of polygonal patterns in a layout, setting a reference point on an edge of the target pattern, obtaining a target raster including kernels overlapping the plurality of polygonal patterns adjacent to the reference point, and comparing the target raster with a hot-spot raster using a pseudo raster pattern matching method.

In example embodiments, the target pattern may be removed from the layout or modified in the layout when the kernels are determined to correspond to hot-spot kernels. In example embodiments, a reference point may be set as a central point on the edge of the target pattern.

In example embodiments, the method may further include setting another reference point adjacent to the reference point, and obtaining another target raster including kernels overlapping the plurality of polygonal patterns adjacent to the other reference point.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a flow chart illustrating a method of designing a photomask layout according to example embodiments of the inventive concepts.

FIG. 2 is a plan view illustrating an example of a target layout.

FIG. 3A is a plan view illustrating a portion of the target layout, in which a reference pattern and first neighboring patterns are provided. FIG. 3B is plan view illustrating projection edge positions 20a, a pattern center position 20b, a line-end position 2c and a pattern space position 20d in FIG. 3A.

FIG. 4 is a plan view illustrating a first target raster at a first target reference point.

FIGS. 5A through 5C are plan views illustrating a square array, a radial array, and a diagonal array, respectively.

FIG. 6 is a diagram illustrating a first target matrix obtained from the first target raster of FIG. 4.

FIG. 7 is a plan view illustrating a second target raster at a second target reference point.

FIG. 8 is a plan view illustrating a failure pattern and second neighboring patterns.

FIG. 9 is a plan view illustrating a hot-spot raster of the failure pattern.

FIG. 10 is a diagram illustrating a 5×5 hot-spot matrix obtained from the hot-spot raster of FIG. 9.

FIG. 11 is a flow chart illustrating a pseudo raster pattern matching process according to example embodiments of the inventive concepts.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As will be described in more detail below, a method of designing a photomask layout according to example embodiments of the inventive concepts may include removing failure patterns or hotspots from a target layout using a pseudo rasterization method and/or a pseudo raster pattern matching method.

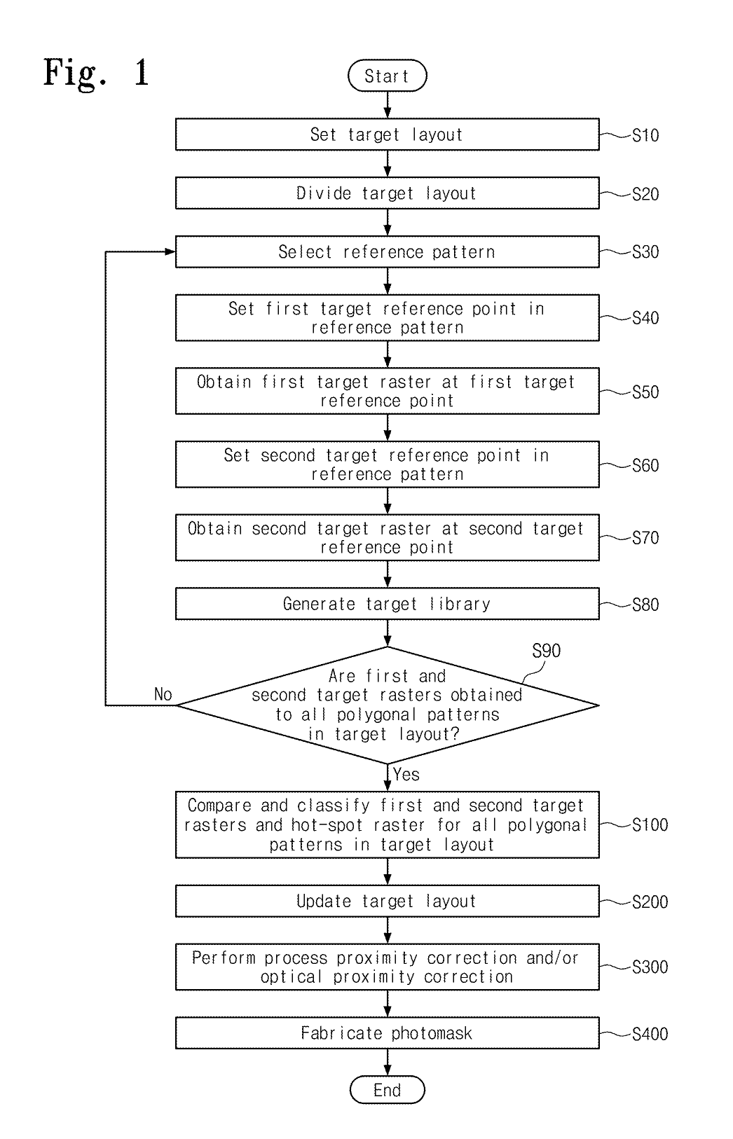

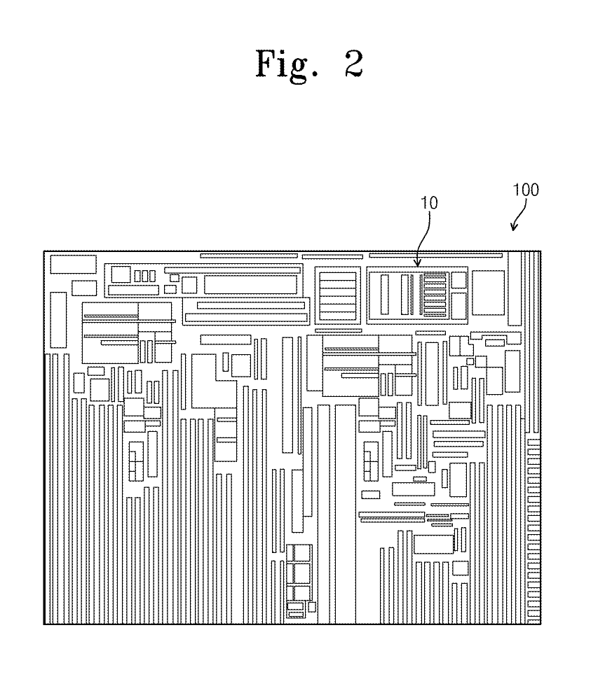

FIG. 1 is a flow chart illustrating a method of designing a photomask layout according to example embodiments of the inventive concepts, and FIG. 2 is a plan view illustrating an example of a target layout.

Referring to FIGS. 1 and 2, a target layout 100 may be set (in S10). The target layout 100 may be configured to have an area corresponding to a single shot of an exposure process. The target layout 100 may be designed depending on the customer's need.

The target layout 100 may be divided by polygonal patterns 10 provided therein (in S20). In example embodiments, the target layout 100 may include polygonal patterns 10 provided to have a line and space structure. In addition, the polygonal patterns 10 may include a pattern shaped like a circle, a triangle, a tetragon, a pentagon, a hexagon, and any combination thereof. Furthermore, some of the polygonal patterns 10 may be configured to have different sizes from each other.

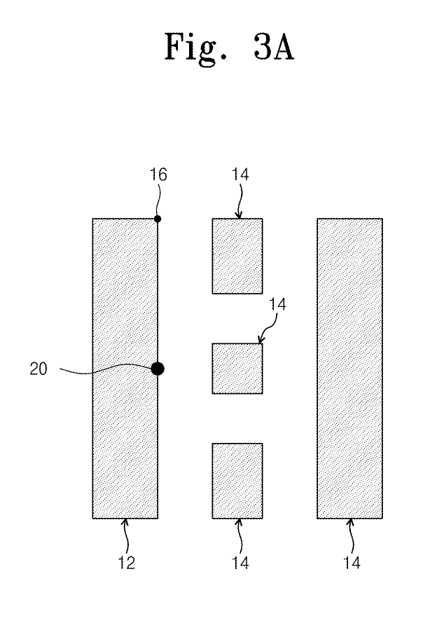

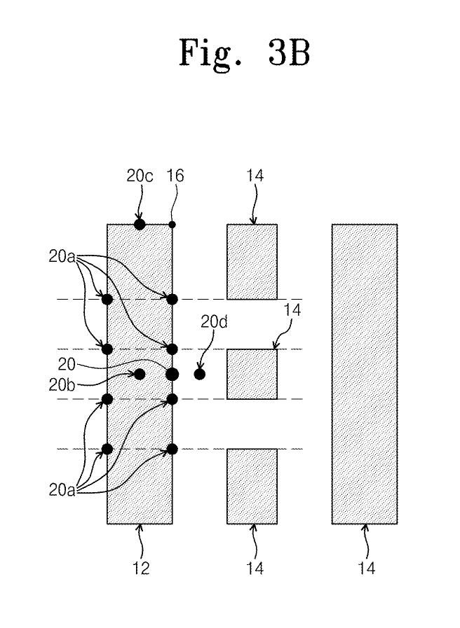

FIG. 3A is a plan view illustrating a portion of the target layout 100, in which a reference pattern 12 and first neighboring patterns 14 are provided. FIG. 3B is plan view illustrating projection edge positions 20a, a pattern center position 20b, a line-end position 2c and a pattern space position 20d in FIG. 3A.

Referring to FIGS. 1 through 3, one of the dissected polygonal patterns 10 may be set as a reference pattern 12 (in S30). In example embodiments, the reference pattern 12 may be a target pattern, which may be located at an arbitrary position (e.g., center or edge) of the divided region of the target layout 100. The reference pattern 12 may be a rectangular pattern. The first neighboring patterns 14 may include at least one square pattern or at least one rectangular pattern provided adjacent to the reference pattern 12.

An edge of the reference pattern 12 is set as a first target reference point 20 in the target layout 100 (in S40). In most of the soft simulations, a pattern matching method may include a verification step using an edge of the polygonal pattern 10 as the reference point. The first target reference point 20 may be set as a center of the edge of the reference pattern 12. Accordingly, the first target reference point 20 may correspond to a first reference point of position coordinates representing the reference pattern 12. Although not shown, the edge of the reference pattern 12 may be divided into a plurality of sections, and in this case, the first target reference point 20 may be given by a plurality of position coordinates. In addition, the first target reference point 20 may correspond to one of vertexes of the reference pattern 12. For example, in the case where the first target reference point 20 corresponds to a specific vertex 16 of the reference pattern 12, the division of the polygonal patterns 10 (in S20) may be omitted, because the reference pattern 12 is uniquely distinguished by the first target reference point 20. Also referring FIG. 3B, the first target reference point 20 may be set at projection edge positions 20a, a pattern center position 20b, a line-end position 2c or a pattern space position 20d. The projection edge positions 20a may be near a vertex of the first neighboring patterns 14. The pattern center 20b may be in a center of the reference pattern 12. The line-end position 2c may be at a line end edge of the reference pattern 12. The pattern space position 20d may be in a space center between the reference pattern 14 and the neighbor patterns 14.

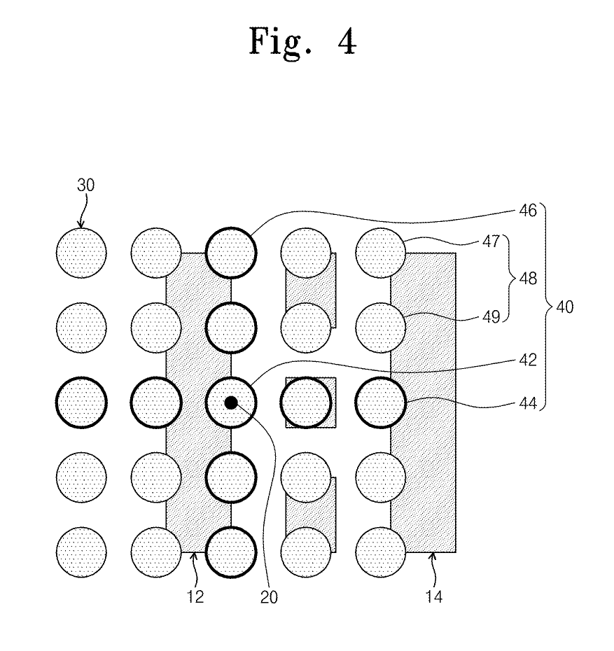

FIG. 4 is a plan view illustrating a first target raster 30 at the first target reference point 20. Referring to FIGS. 1 through 4, a first target raster 30 with first target kernels 40 may be obtained in such a way that some of the first target kernels 40 are overlapped with the first neighboring patterns 14 provided adjacent to the first target reference point 20 (in S50). The first target raster 30 may include a first array with the first target kernels 40 arranged around the first target reference point 20. In example embodiments, the first target kernels 40 of the first array may be spaced apart from each other by a uniform space. Each of the first target kernels 40 may be provided to have a circular shape. In example embodiments, the first target kernels 40 may be arranged to have a 5-by-5 tetragonal array structure. For example, the first target kernels 40 may include a first central target kernel 42 serving as the first target reference point 20, first horizontal central target kernels 44, first vertically centered target kernels 46, and first remaining target kernels 48. The first remaining target kernels 48 may include first diagonal target kernels 47 and adjacent target kernels 49 adjacent to the first diagonal target kernels 47.

The first target kernels 40 may overlap the first neighboring patterns 14. Each of the first target kernels 40 may include a circle whose diameter is smaller than half of the distance from the reference pattern 12 to the first neighboring patterns 14 adjacent thereto. The first target kernels 40 may be converted into a distribution density corresponding to an area overlapping the first neighboring patterns 14. The distribution density may be obtained from one of distribution functions, e.g., circle function, Gaussian function, Lorentzian function, Bessel function, and Zernike function. The first target raster 30 may be regarded as a vector corresponding to the density at the first target reference point 20. The first target raster 30 of the first target reference point 20 may be obtained by a pseudo rasterization.

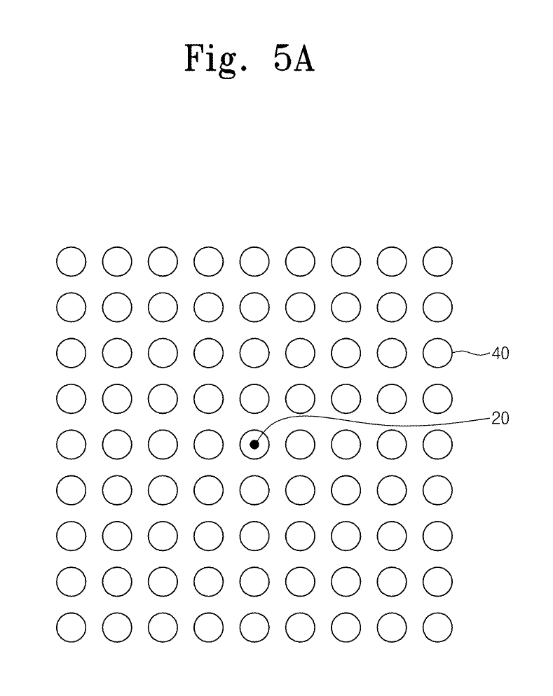

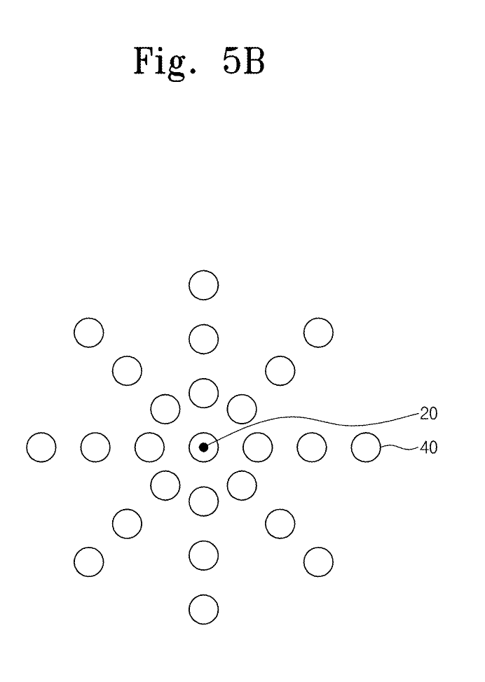

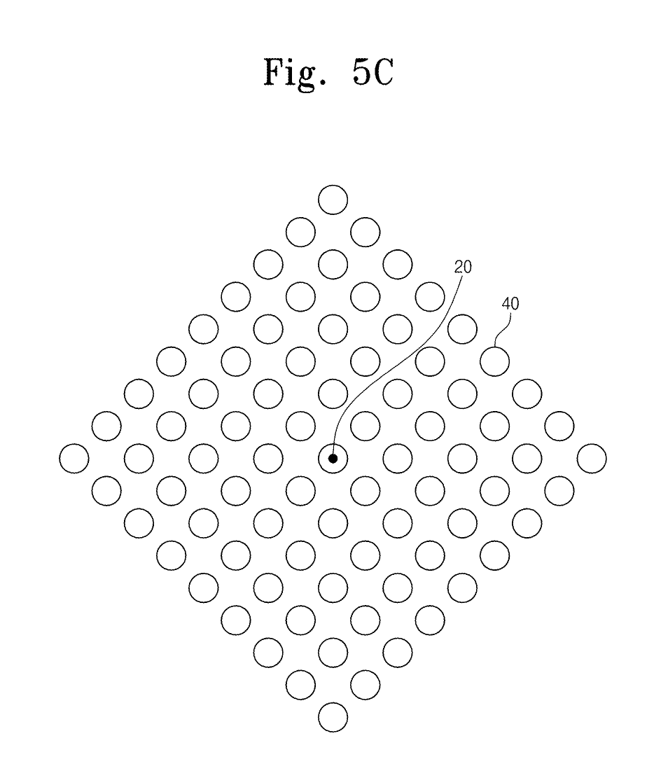

FIGS. 5A through 5C are plan views illustrating a square array, a radial array, and a diagonal array, respectively. Referring to FIGS. 5A through 5C, the first target kernels 40 may be arranged around the first target reference point 20 to have one of square (FIG. 5A), radial (FIG. 5B), or diagonal (FIG. 5C) array. For example, the first target kernels 40 may be arranged to form the square array of N-by-M, where N and M may be odd natural numbers. In example embodiments, the numbers N and M may be the same as each other. For example, the first target kernels 40 may be arranged to form the square array of 9-by-9. Alternatively, the first target kernels 40 may be radially arranged along horizontal, vertical, and diagonal directions with respect to the first target reference point 20, thereby forming the radial array. In example embodiments, the diagonal array may include a tetragonal or diamond-shaped array, which may correspond to the square array rotated around the first target reference point 20 by 45 degrees.

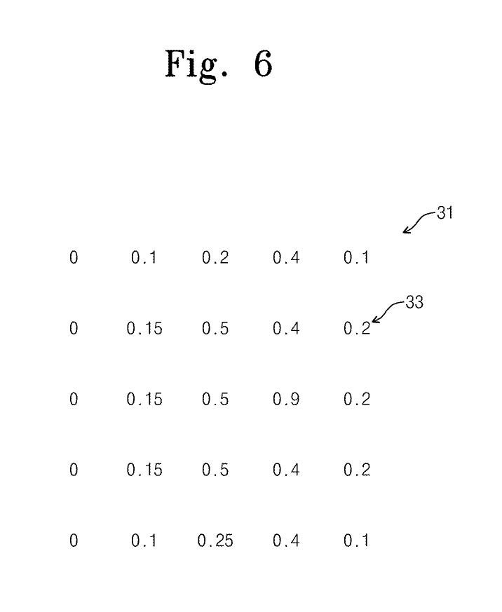

FIG. 6 is a diagram illustrating a first target matrix 31 obtained from the first target raster 30 of FIG. 4. Referring to FIGS. 1, 4 and 6, the first target raster 30 may be used to obtain a first target matrix 31. The first target matrix 31 may have first elements 33 represented by a distribution density corresponding to each of the first target kernels 40 of the first target raster 30. In example embodiments, each of the first elements may have a value from 0 to 1. The first target matrix 31 may be represented by a vector defined at the first target reference point 20. In other words, the first target raster 30 may also be represented by the vector defined at the first target reference point 20. The first target matrix 31 at the first target reference point 20 may be obtained by a pseudo rasterization. In example embodiments, the first target reference point 20 may be indexed on the basis of the first target matrix 31.

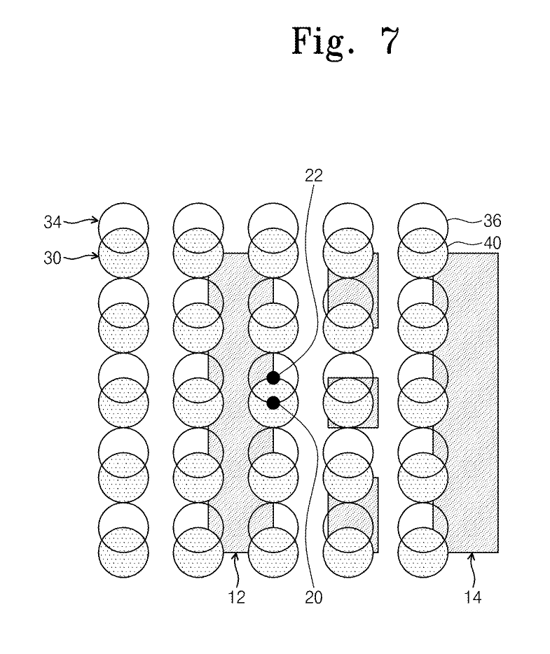

FIG. 7 is a plan view illustrating a second target raster 34 at a second target reference point 22 determined adjacent to the first target reference point 20. Referring to FIGS. 1 and 7, a point may be set as a second target reference point 22 (in S60). The second target reference point 22 may be set to be spaced apart from the first target reference point 20 by a specific distance. In example embodiments, the second target reference point 22 may be selected based on user's input (for example, as a point adjacent to the first target reference point 20). For example, the second target reference point 22 may be selected to be a point in the reference pattern 12, which may be located around the first target reference point 20. In example embodiments, the second target reference point 22 may be a point on the edge or center of the reference pattern 12. The distance and direction of the second target reference point 22 from the first target reference point 20 may be set by the user's input.

A second target raster 34 may be obtained for the second target reference point 22 (in S70). The second target raster 34 may include second target kernels 36. The second target kernels 36 may be arranged in the same manner as the first target kernels 40. The second target raster 34 may be represented by a second target matrix defined at the second target reference point 22.

Referring back to FIGS. 1, 2 and 7, a target library may be generated based on the first and second target rasters 30 and 34 at the first and second target reference points 20 and 22 (in S80). In the target library, the first target matrix 31 may be stored along with coordinates corresponding to the first target reference point 20 of the polygonal patterns 10 in the target layout 100. Similarly, the second target matrix may be stored along with coordinates corresponding to the second target reference point 22.

Thereafter, it may be determined whether the first and second target rasters 30 and 34 and the first and second target matrices 31 thereof are obtained to all the polygonal patterns 10 in the target layout 100 (in S90). All the polygonal patterns 10 in the target layout 100 may be represented as the first and second target rasters 30 and 34, which may be obtained by the pseudo rasterization on each of the first and second target reference points 20 and 22. By using the first and second target rasters 30 and 34, a pattern matching operation can be more rapidly performed compared with the conventional methods, e.g., a design rule check method or an image matching method. The layout design method according to example embodiments of the inventive concepts can be realized with improved productivity and effectiveness.

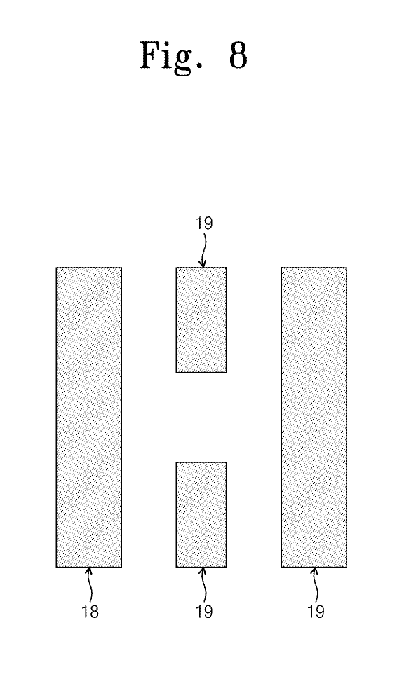

Information on failure patterns in a photolithography and/or etching process may be delivered from a process engineer to a layout designer. Alternatively, the information on the failure patterns may be obtained from simulations. In this case, the layout designer may want to detect and remove quickly a pattern resembling the failure pattern from the target layout. For example, the pseudo rasterization, which will be described in more detail with reference to FIG. 8, may be used to represent the failure patterns as a hot-spot raster.

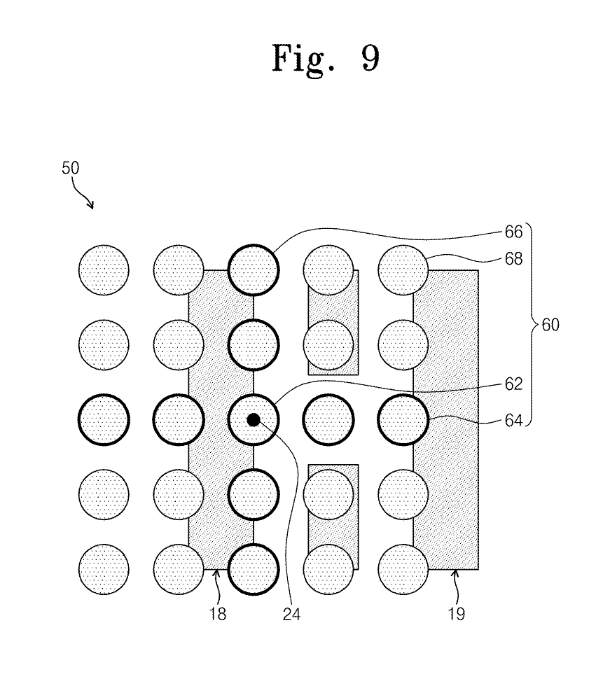

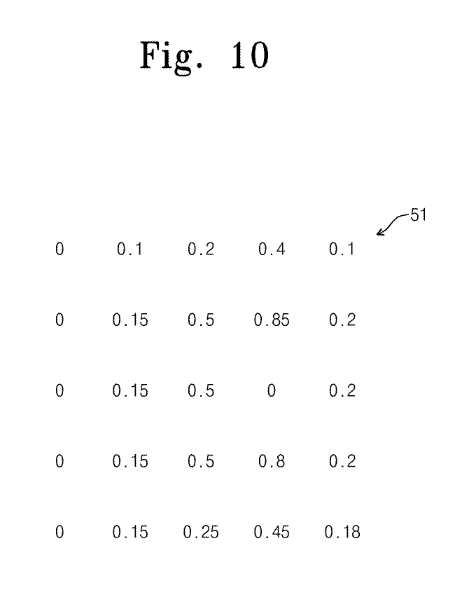

FIG. 8 is a plan view illustrating the failure pattern 18 and second neighboring patterns 19. FIG. 9 is a plan view illustrating a hot-spot raster 50 of the failure pattern 18. FIG. 10 is a diagram illustrating a 5×5 hot-spot matrix obtained from the hot-spot raster 50 of FIG. 9.

Referring to FIGS. 8 through 10, the pseudo rasterization may include setting a hot-spot reference point 24 of a failure pattern 18 and obtaining a hot-spot raster 50 at the hot-spot reference point 24. The failure pattern 18 may be a hot-spot pattern adjacent to the second neighboring patterns 19. The hot-spot reference point 24 may be a second reference point located at a center of an edge of the failure pattern 18. The hot-spot raster 50 may be a square array including 5-by-5 hot-spot kernels 60. The hot-spot kernels 60 may overlap the second neighboring patterns 19. Each of the hot-spot kernels 60 may include a circle whose diameter is smaller than half of the distance from the second neighboring patterns 19 adjacent to the failure pattern 18.

The hot-spot kernels 60 may include a central hot-spot kernel 62 serving as the hot-spot reference point 24, horizontal central hot-spot kernels 64, vertical central hot-spot kernels 66, and remaining hot-spot kernels 68, which may serve as second kernels. The hot-spot raster 50 may correspond to the hot-spot matrix 51, which may be obtained from a distribution density of the hot-spot kernels 60 overlapping the second neighboring patterns. The hot-spot raster 50 at the hot-spot reference point 24 may be obtained by a pseudo rasterization. The hot-spot raster 50 may be stored in a hot-spot library (not shown).

Referring back to FIGS. 1 through 10, the first and second target rasters 30 and 34 and the hot-spot raster 50 associated with each of the polygonal patterns 10 in the target layout 100 may be compared and classified based on the target library (in S100). In the case where the number of the first target kernels 40 is equal to that of the hot-spot kernels 60, the target raster 30 may be compared to the hot-spot raster 50. Comparison and classification of the target raster 30 and the hot-spot raster 50 (in S100) may be performed using a pseudo raster pattern matching process. For example, the pseudo raster pattern matching process according to example embodiments of the inventive concepts may include the following operating steps, which may be performed by a computer in a pattern window system.

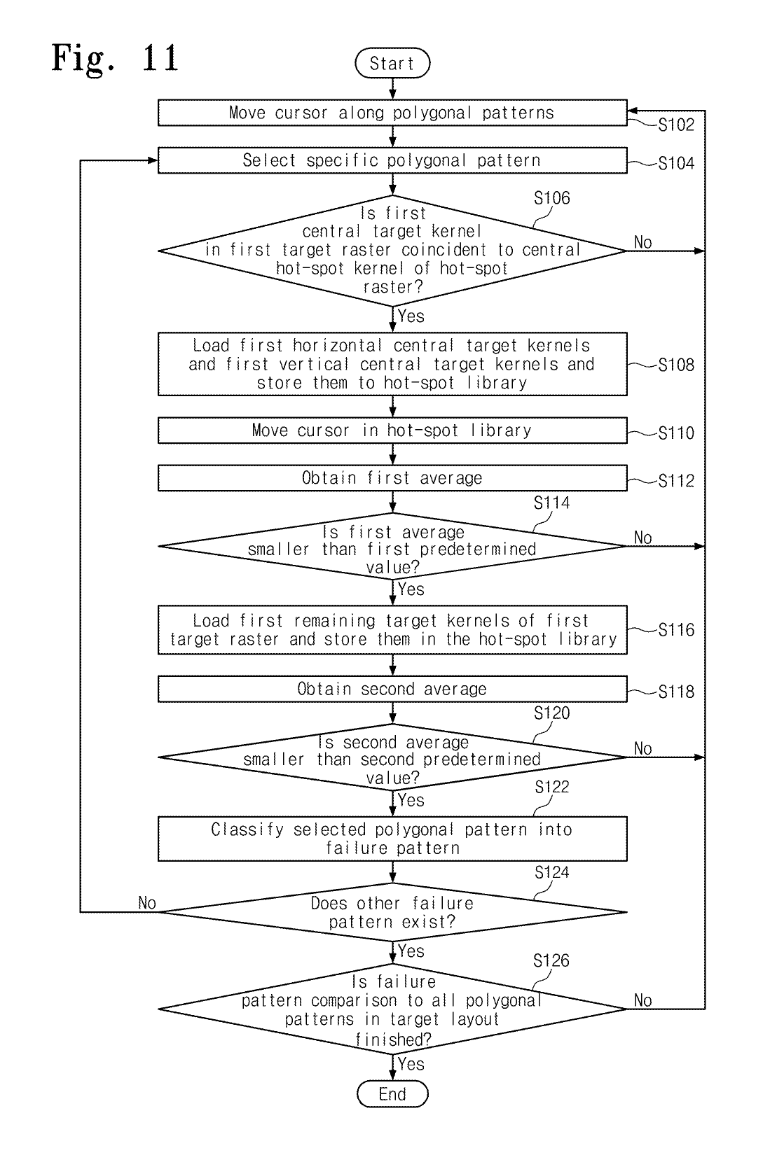

FIG. 11 is a flow chart illustrating a pseudo raster pattern matching process according to example embodiments of the inventive concepts. Referring to FIGS. 2, 4, 9 and 11, a cursor may be moved along the polygonal patterns 10 of the target layout 100 (in S102) and, during this movement of the cursor, a specific polygonal pattern 10 may be selected from a target object (in S104). The specific polygonal pattern 10 may be arbitrarily selected from the target layout 100.

It may be determined whether the first central target kernel 42 in the first target raster 30 of the specific polygonal pattern (e.g., the reference pattern 12) may be coincident to the central hot-spot kernel 62 of the hot-spot raster 50 (in S106). The hot-spot raster 50 may be compared with the first target raster 30. The first central target kernel 42 and the central hot-spot kernel 62 may be represented by distribution densities at the first target reference point 20 and the hot-spot reference point 24 and serve as first reference elements for the pattern matching. In the case where the first central target kernel 42 is not coincident with the central hot-spot kernel 62, the cursor may be moved to other polygonal pattern in the target layout 100 (in S102) and the target raster 30 at the moved polygonal pattern may be compared to the hot-spot raster 50. In example embodiments, the first central target kernel 42 and the central hot-spot kernel 62 may have the same distribution density of 0.5.

Thereafter, in the case where the first central target kernel 42 is coincident with the central hot-spot kernel 62, the first horizontal central target kernels 44 and the first vertical central target kernels 46 in the target raster 30 may be loaded or stored from the target library to the hot-spot library (in S108). For example, the hot-spot library may store elements of the first target matrix 31 corresponding to the first horizontal central target kernels 44 and the first vertical central target kernels 46.

The cursor may be moved along the failure pattern 18 in the hot-spot library (in S110) to compare the first horizontal central target kernels 44 and the first vertical central target kernels 46 with the horizontal central hot-spot kernels 64 and the vertical central hot-spot kernels 66, respectively, of the hot-spot target raster 50 (in S112). The first and second horizontal central kernels 44 and 64 and the first and second vertical central kernels 46 and 66 may be compared by an average of differences in value corresponding to discrepancies thereof (hereinafter, referred as to a “first average”). For example, the first average may be given by the following equation 1.

$$D = \frac{{\sum }_{n} {k}_{ij} \vert {t}_{ij} - {p}_{ij} \vert}{N} , \qquad [ Equation 1 ]$$

where D represents the average, kij is a weighting depending on a distance from the first target reference point 20 or the hot-spot reference point 24 to the first target kernels 40 or the hot-spot kernels 60, tij is elements of the first target matrix 31 corresponding to the first target kernels 40 of the first target raster 30, pij is elements of the hot-spot matrix 51 corresponding to the hot-spot kernels 60 of the hot-spot raster 50, and N is the number of the first target kernels 40 or the hot-spot kernels 60 under comparison. In more detail, the average may be given by dividing a sum of absolute values (e.g., |tij-pij|) of differences between the first target kernels 40 and the hot-spot kernels 60 by the number N. In addition, as given by the Equation 1, the average may have a dependency on the weighting kij. For example, in the case of comparing FIG. 6 to FIG. 10, the first average may be obtained from nine elements including the horizontal central elements and the vertical central elements. For kij=1, the first average of the hot-spot raster 50 and the target raster 30 may be 0.01.

Thereafter, the first average may be compared to a first predetermined or given value (in S114). The first average and the first predetermined or given value may be considered to determine whether the comparison between the first target raster 30 and the hot-spot raster 50 will be continued or not. The first predetermined or given value may be input by a user. If the first average is greater than the first predetermined or given value, the cursor may be moved to other polygonal pattern in the target layout (in S102) and the target raster 30 at the moved polygonal pattern may be compared to the hot-spot raster 50.

If the first average is smaller than the first predetermined or given value, the first remaining target kernels 48 of the first target raster 30 may be loaded and stored in the hot-spot library (in S116). For example, if the first average is 0.01 and the first predetermined or given value is greater than 0.01, the hot-spot library may store elements of the first target matrix 31 corresponding to the first remaining target kernels 48.

A second average may be obtained to have a value corresponding differences among the first and second horizontal central kernels 44 and 64, the first and second vertical central kernels 46 and 66, and the first and second remaining kernels 48 and 68 (in S118). In example embodiments, the second average may be dependent on the first average. For example, similar to the first average, the second average may be given by the Equation 1. If kij=1, the second average of the hot-spot raster 50 and the first target raster 30 may be 0.0552.

Thereafter, the second average may be compared to a second predetermined or given value (in S120). The second predetermined or given value may be input by the user. If the second average is greater than the second predetermined or given value, the selected polygonal pattern 10 may be classified into a normal pattern and the cursor may be moved to another polygonal pattern (in S102) to compare the first target raster 30 with the hot-spot raster 50 at the moved polygonal pattern.

Thereafter, if the second average is smaller than the second predetermined or given value, the selected polygonal pattern 10 may be classified into the failure pattern 18 (in S122). For example, the selected polygonal pattern 10 may be classified into the hot-spot pattern.

It may be determined whether the pattern matching operation has been executed to some of the failure patterns (hereinafter, referred as the “remaining failure patterns”) having different shapes from that considered in the previous routine including the steps S104 to S122 (in S124). If the remaining failure patterns exist, the routine including the steps S104 to S122 may be performed to the remaining failure patterns, by the number of times corresponding to the number of the remaining failure patterns.

Finally, it may be determined whether the pattern matching operation has been performed to all of the polygonal patterns 10 in the target layout 100 (in S126). By using the pseudo raster pattern matching method, it is possible to more rapidly detect the polygonal pattern 10 corresponding to the failure pattern 18 from the target layout 100, compared with the conventional methods, e.g., a design rule check method or an image matching method. In addition, the pseudo raster pattern matching method may have reliability higher than that in the design rule check method.

Accordingly, the pseudo raster pattern matching method according to example embodiments of the inventive concepts can provide higher productivity compared with the conventional methods. So far, a method of comparing the first target raster 30 at the first target reference point 20 to the hot-spot raster 50 has been described as an example of the pseudo raster pattern matching method on the reference pattern 12 and the failure pattern 18, but example embodiments of the inventive concepts may not be limited thereto. For example, a way of comparing the second target raster 34 of the reference pattern 12 to the hot-spot raster 50 may be used to determine whether the reference pattern 12 can be classified into the failure pattern 18 or not.

Referring back to FIGS. 1 and 2, the target layout 100 may be updated on the basis of the above result (in S200). For example, some of the polygonal patterns 10, which may be classified into the failure pattern 18 by the pattern matching method, may be removed from or changed in the target layout 100. Alternatively, the target layout 100 may remain as is if there is no polygonal pattern that can be classified into the hot-spot pattern.

A process proximity correction and/or an optical proximity correction may be performed on the target layout 100 (in S300). By using the process proximity correction and/or the optical proximity correction, real patterns to be realized on a wafer can have the same shape as the target layout 100. For example, the process proximity correction may be prepared in consideration of a plasma power, an electrode type, and/or an electrode height of an etching apparatus to be used. During the process proximity correction, the target layout 100, which may be updated on the basis of the pseudo raster pattern matching operation, may be used to generate a post-development measurement layout. The optical proximity correction may be prepared in consideration of process conditions in a photolithography process (e.g., a wavelength of a light source and/or illumination conditions). During the optical proximity correction, the post-development measurement layout may be used to generate a photomask layout. Because process apparatus for the corrections have properties and limitations of their own, the process proximity correction and the optical proximity correction may be performed on the target layout in a similar manner, e.g., by changing merely correction or change values. For all that, example embodiments of the inventive concepts may not be limited to the above example. The post-development measurement layout or the photomask layout may be updated by the pseudo rasterization method and the pseudo raster pattern matching method, and thus, some of the polygonal patterns corresponding to the hot-spot pattern may be removed from the post-development measurement layout or the photomask layout.

Thereafter, a photomask may be fabricated (in S400). According to example embodiments of the inventive concepts, the photomask mask may be fabricated to include patterns transcribed from the target layout 100, in which polygonal patterns corresponding to the hot-spot pattern are removed or modified by the pseudo rasterization method and the pseudo raster pattern matching method.

As a result, according to example embodiments of the inventive concepts, the pseudo rasterization method and the pseudo raster pattern matching method can be used to increase and maximize productivity in a process of designing a photomask layout.

According to example embodiments of the inventive concepts, a pseudo rasterization method may include setting a reference point on an edge of one of polygonal patterns in a target layout and obtaining target rasters including kernels. The kernels may correspond to distribution densities obtained from the polygonal patterns adjacent to the reference point. The target rasters may be compared with a hot-spot raster by a pseudo raster pattern matching method. If the polygonal pattern has a target raster coincident to the hot-spot raster, it may be removed from or modified in the target layout. By using the pseudo raster pattern matching method, an operation of detecting a failure pattern from the target layout can be more rapidly performed compared with the conventional methods, e.g., a design rule check method or an image matching method. As a result, it is possible to increase and maximize productivity in a process of designing a photomask layout.

While example embodiments of the inventive concepts have been particularly shown and described, it will be understood by one of ordinary skill in the art that variations in form and detail may be made therein without departing from the spirit and scope of the attached claims.

What is claimed is:

1. A method of designing a photomask layout, the method comprising:
selecting a target pattern from polygonal patterns in a layout;
setting a reference point on the target pattern;
obtaining a target raster at the reference point; and
comparing the target raster with a hot-spot raster to determine whether the target pattern corresponds to a failure pattern.

2. The method of claim 1, wherein the target raster and the hot-spot raster include first and second arrays having first and second kernels, respectively.

3. The method of claim 2, further comprising:
converting each of the first and second kernels into a distribution density corresponding to an area overlapping the polygonal patterns adjacent to the reference point.

4. The method of claim 2, wherein each of the first and second kernels includes a circle whose diameter is smaller than half of a minimum pitch between the polygonal patterns.

5. The method of claim 2, wherein the comparing the target raster with a hot-spot raster includes:
averaging absolute values of differences between the first and second kernels, and
comparing the average with a given value.

6. The method of claim 5, wherein the averaging calculates a weighting depending on a distance from the reference point to one of the first kernel and to the second kernel.

7. The method of claim 2, wherein each of the first and second kernels includes a central kernel, horizontal central kernels, vertical central kernels, and remaining kernels if the first and second arrays are square-shaped.

8. The method of claim 7, wherein the comparing the target raster with a hot-spot raster includes:
comparing the central kernels of the first and second arrays with each other,
comparing the horizontal central kernels and the vertical central kernels of the first and second arrays with each other if the central kernel of the first array is coincident to the central kernel of the second array, and
comparing the remaining kernels of the first and second arrays with each other if the horizontal central kernels and the vertical central kernels of the first array are coincident to a corresponding one of the horizontal central kernels and the vertical central kernels of the second array.

9. The method of claim 8, wherein the comparing the horizontal central kernels and the vertical central kernels of the first and second arrays with each other includes:
averaging absolute values of differences between the horizontal central kernels and the vertical central kernels of the first and second arrays to obtain a first average, and
comparing the first average with a first given value.

10. The method of claim 8, wherein the comparing the remaining kernels of the first and second arrays with each other includes:
averaging absolute values of differences between the remaining kernels of the first and second arrays to obtain a second average, and
comparing the second average with a second given value.

11. The method of claim 3, wherein the converting each of the first and second kernels calculates the distribution density using one of circle function, Gaussian function, Lorentzian function, Bessel function, and Zernike function.

12. The method of claim 2, wherein each of the first and second arrays is one of a square, radial, and diagonal array.

13. The method of claim 1, wherein the setting a reference point sets a central point on an edge of the target pattern.

14. A method of designing a photomask layout, comprising:
setting a target layout;
dividing the target layout into polygonal patterns;
selecting a target pattern from the polygonal patterns;
setting a first reference point on the target pattern;
obtaining a first target raster having first target kernels overlapping the polygonal patterns adjacent to the first reference point;
correlating the first target raster with the first reference point of the target pattern to generate a target library; and
comparing the first target raster with a hot-spot raster to determine whether the target pattern corresponds to a failure pattern.

15. The method of claim 14, further comprising,
setting a second reference point adjacent to the first reference point; and
obtaining a second target raster having second target kernels overlapping the polygonal patterns adjacent to the second reference point.

16. The method of claim 14, further comprising:
removing the target pattern from the target layout or modifying the target pattern in the target layout when the first target kernels are determined to correspond to hot-spot kernels.

17. A method of designing a photomask layout, the method comprising:
selecting a target pattern from one of a plurality of polygonal patterns in a layout;
setting a reference point on an edge of the target pattern;
obtaining a target raster including kernels overlapping the plurality of polygonal patterns adjacent to the reference point; and
comparing the target raster with a hot-spot raster using a pseudo raster pattern matching method.

18. The method of claim 17, further comprising:
removing the target pattern from the layout or modifying the target pattern in the layout when the kernels are determined to correspond to hot-spot kernels.

19. The method of claim 17, wherein the setting a reference point sets a central point on the edge of the target pattern.

20. The method of claim 17, further comprising,
setting another reference point adjacent to the reference point; and
obtaining another target raster including kernels overlapping the plurality of polygonal patterns adjacent to the other reference point.
